(19) United States
(12) Patent Application Publication
(10) Pub. No.: US 2013/0189916 A1
(43) Pub. Date: Jul. 25, 2013

(54) RACK SYSTEM AND VENTILATION APPARATUS THEREOF

(71) Applicants: Peng-Yuan CHEN, Taoyuan County (TW); Ming-Feng KANG, Taoyuan County (TW)

(72) Inventors: Peng-Yuan CHEN, Taoyuan County (TW); Ming-Feng KANG, Taoyuan County (TW)

(73) Assignee: DELTA ELECTRONICS, INC., Taoyuan County (TW)

(21) Appl. No.: 13/564,093

(22) Filed: Aug. 1, 2012

(30) Foreign Application Priority Data
Jan. 20, 2012 (TW) 101102728

(51) Int. Cl. G06F 1/20

(52) U.S. Cl. 454/229; 62/186; 454/239

(57) ABSTRACT

In a rack system and a ventilation apparatus, the rack system includes a closed rack, a chassis and a cooling device. The chassis is installed in the closed rack; the cooling device is contained in the closed rack and disposed adjacent and parallel to the chassis; the cooling device and the chassis jointly separate an interior space of the closed rack into a cold air channel and a hot air channel; the cooling device has an air outlet and an air inlet, and the air outlet is corresponsive to the cold air channel, and the air inlet is corresponsive to the hot air channel. The cold air channel and the hot air channel can uniformly dissipate the heat generated by stacked servers inside the chassis, so that the rack system has high energy efficiency.

### FIELD OF THE INVENTION

The present invention relates to a rack or a system case for information equipments, in particular to a rack system and its ventilation apparatus.

### BACKGROUND OF THE INVENTION

As network technologies advance, the market and demand of servers become increasingly greater, and the major feature of the server resides on its powerful computing capability. However, the more powerful the computing capability, the greater is the quantity of heat produced during the operation of the server. After a long time of use, the operation performance of the server may be affected adversely or even the server may be damaged. To overcome this problem, manufacturers generally install the server at a heat dissipating rack with good ventilation.

The server is usually placed in the heat dissipating rack at an office to avoid hot air exhausted from the rear of the rack and noises generated by a fan in the rack from affecting the staffs in the office, and the heat dissipating rack is generally designed as a closed rack. With reference to FIG. 1 for a conventional closed rack 10, the conventional closed rack 10 comprises a chassis 20 and a cooling device 30, and the heat generated from the chassis 20 is dragged through the cooling device 30 to form a hot air 40 that flows into the cooling device 30, and then passes through the cooling device 30 to cool the hot air 40 into a cold air 50, and finally the cold air 50 enters into the chassis 20 to define a cold/hot air circulation loop.

However, there is a distance between the chassis 20 and the cooling device 30, and the cold air 50 is blown from the bottom of the chassis 20 into the chassis 20, and thus it is easy to have a non-uniform heat dissipation problem, wherein the temperature of a server installed at the bottom of the chassis 20 is lower, and the temperature of the server installed at the top of the chassis 20 is higher. In addition, the closed rack 10 takes no measures when the cooling device 30 is failed, so that heat will be accumulated continuously in the closed rack 10 and the server may be damaged in a worse scenario. Even if the temperature of the external environment or the temperature of the hot air 40 is low, the aforementioned cooling device 30 still keeps running continuously and causes unnecessary waste of energy sources. In view of these problems of the prior art, the inventor of the present invention conducted extensive researches and experiments, and finally provided a feasible design to overcome the problems.

### SUMMARY OF THE INVENTION

Therefore, it is a primary objective of the present invention to provide a rack system comprising: a cooling device and a chassis arranged adjacent and parallel to each other and jointly separating the interior space of the closed rack into a cold air channel and a hot air channel, so that the heat generated by stacked servers in the chassis can be dissipated uniformly, and the rack system of the present invention can have high energy efficiency.

To achieve the aforementioned objective, the present invention provides a rack system, comprising: a closed rack; a chassis, installed in the closed rack; and a cooling device, installed in the closed rack and disposed adjacent and parallel to the chassis, wherein the cooling device and the chassis jointly separate the interior space of the closed rack into a cold air channel and a hot air channel, and the cooling device has an air outlet and an air inlet, and the air outlet is corresponsive to the cold air channel, and the air inlet is corresponsive to the hot air channel.

Another objective of the present invention is to provide a rack system that turns on a ventilation device when the aforementioned rack system runs into a special situation such as a high temperature occurred inside the cold air channel or a malfunction of the cooling device, so as to achieve the effect of decreasing the temperature of the rack system during emergency.

To achieve the aforementioned objective, the present invention provides a ventilation apparatus of a rack system, comprising: a rack; a chassis, installed in the rack; a cooling device, installed in the rack and disposed adjacent and parallel to the chassis, wherein the cooling device and the chassis jointly separate the interior space of the closed rack into a cold air channel and a hot air channel, and the cooling device has an air outlet and an air inlet, and the air outlet is corresponsive to the cold air channel, and the air inlet is corresponsive to the hot air channel; a ventilation device, including a switching air extraction door and a switching air exhaustion door installed at the rack, wherein the switching air extraction door is corresponsive to the cold air channel, and the switching air exhaustion door is corresponsive to the hot air channel; a sensor, installed at the cold air channel, for sensing a temperature change of an external air and outputting an electrical signal; and a controller, electrically coupled to the sensor, for receiving the electrical signal to turn on the ventilation device.

Another objective of the present invention is to provide a rack system that turns on a ventilation device to guide and use external airflow as a cold source to dissipate and discharge heat when the aforementioned rack system encounters a special situation such as a low temperature occurred at the exterior of the rack, so as to achieve the power saving effect of the rack system of the present invention.

To achieve the aforementioned objective, the present invention provides a ventilation apparatus of a rack system, the ventilation apparatus comprises: a rack; a chassis, installed in the rack; a cooling device, installed in the rack and disposed adjacent and parallel to the chassis, and the chassis jointly separating an interior space of the closed rack into a cold air channel and a hot air channel, and the cooling device having an air outlet and an air inlet, and the air outlet being arranged at a position corresponding to the cold air channel, and the air inlet being arranged at a position corresponding to the hot air channel; a ventilation device, including a switching air extraction door and a switching air exhaustion door installed at the rack, and the switching air extraction door being arranged corresponding to the cold air channel, and the switching air exhaustion door being arranged corresponding to the hot air channel; a sensor, installed outside the rack, for sensing a temperature change of outside air and outputting an electrical signal; and a controller, electrically coupled to the sensor, for receiving the electrical signal to turn on the ventilation device.

The present invention further has the following effects.

The rack system of the present invention is divided into two modes: a closed circulation mode and a ventilation mode. For the closed circulation mode, the cooling device and the chassis are adjacent and parallel to each other and jointly separate an interior space of the closed rack into a cold air channel and a hot air channel. In other words, an opening formed on a side of the chassis is interconnected to the cold air channel, such that servers stacked in the chassis can achieve the effect of uniformly dissipating heat. In the meantime, the rack system of the present invention can shorten the air delivering distance to reduce the work of driving the air and the energy loss occurred during the air delivering process. Therefore, the rack system of the present invention can have high energy efficiency.

Further, the closed rack defines a closed space, so that it is not necessary to take the effect of external air flows into consideration, and the closed rack can be installed at any corner of an office or a factory. In the meantime, the closed rack has an independent cooling device capable of isolating noises produced by the server fans and cooling devices, and hot air will not be discharged to affect the external environment or working staffs in the office or factory.

If the internal temperature of the cold air channel is high, a possible situation includes a failure of the cooling device in one of the ventilation modes, and the system starts the ventilation device to guide external airflow directly to dissipate and discharge heat, so as to achieve the effect of lowering the temperature of the rack system of the rack system of the present invention immediately in urgent cases. In addition, when the temperature of the environment is low, external airflow is guided and used as a cold source which is another ventilation mode, so that the system will turn on the ventilation device to guide the external airflow directly to dissipate and discharge the heat, so as to achieve a power saving effect of the rack system of the present invention.

The present invention uses the chassis to separate the cold air channel and the hot air channel to avoid a short circulation of cold/hot air and guide cold air into the chassis to improve the heat dissipating effect of the rack system of the present invention. In addition, the rack system and the ventilation apparatus of the present invention have independent heat dissipating systems, so that the invention simply requires users to connect a network and a power cord for the operation, and the rack system of the present invention features a simple and easy installation.

In the closed circulation mode of the present invention, a cold/hot air circulation system is formed naturally in the closed rack, and a controller is provided for adjusting an air flow or temperature of the air outlet to a predetermined temperature to lower electric power consumption by a control of the variable flow, so as to achieve the energy saving effect.

If the internal temperature of the cold air channel is high, the cooling device may fail, and the alarm is on, wherein a light is lit or a siren is issued to transmit an abnormal message to inform maintenance personnel to inspect the cooling device and enhance the safety of using the rack system of the present invention.

The rack (or closed rack) includes a plurality of chassis to facilitate the capacity expansion or layout of the servers, wherein the size of the rack (or closed rack) is adjusted for the assembly to expand the chassis. In addition, the space of the rack (or closed rack) is increased, such that plural cooling devices, switching air extraction doors, switching air exhaustion doors and switching extraction fans can be installed to stabilize the heat dissipating effect of the rack system of the rack system of the present invention and prevent the interior of the rack (or closed rack) from having the problems of non-uniform temperature or heat accumulation.

### BRIEF DESCRIPTION OF THE DRAWINGS

FIG. 1 is a schematic view of a conventional closed rack;

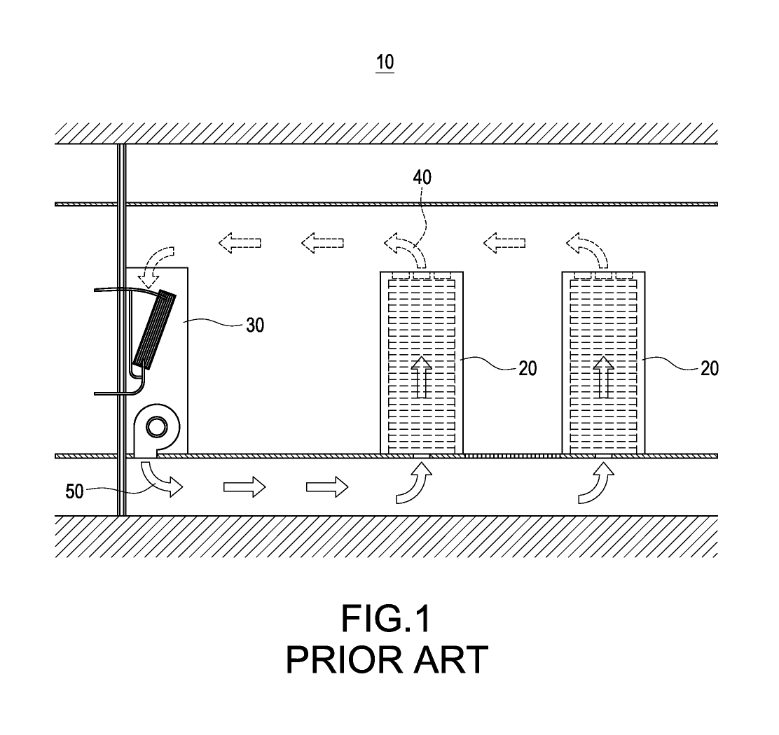

FIG. 2 is a schematic view of a rack system of the present invention;

FIG. 3 is a cross-sectional view of a rack system of the present invention;

FIG. 4 is a schematic view of an application of a rack system of the present invention;

FIG. 5 is a schematic view of an application of a ventilation apparatus of the present invention;

FIG. 6 is a flow chart of a rack system of the present invention;

FIG. 7 is another flow chart of a rack system of the present invention;

FIG. 8 is a perspective view of a rack system of another preferred embodiment of the present invention;

FIG. 9 is a schematic view of an application of a rack system of another preferred embodiment of the present invention; and

FIG. 10 is a schematic view of an application of a rack system of a further preferred embodiment of the present invention.

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

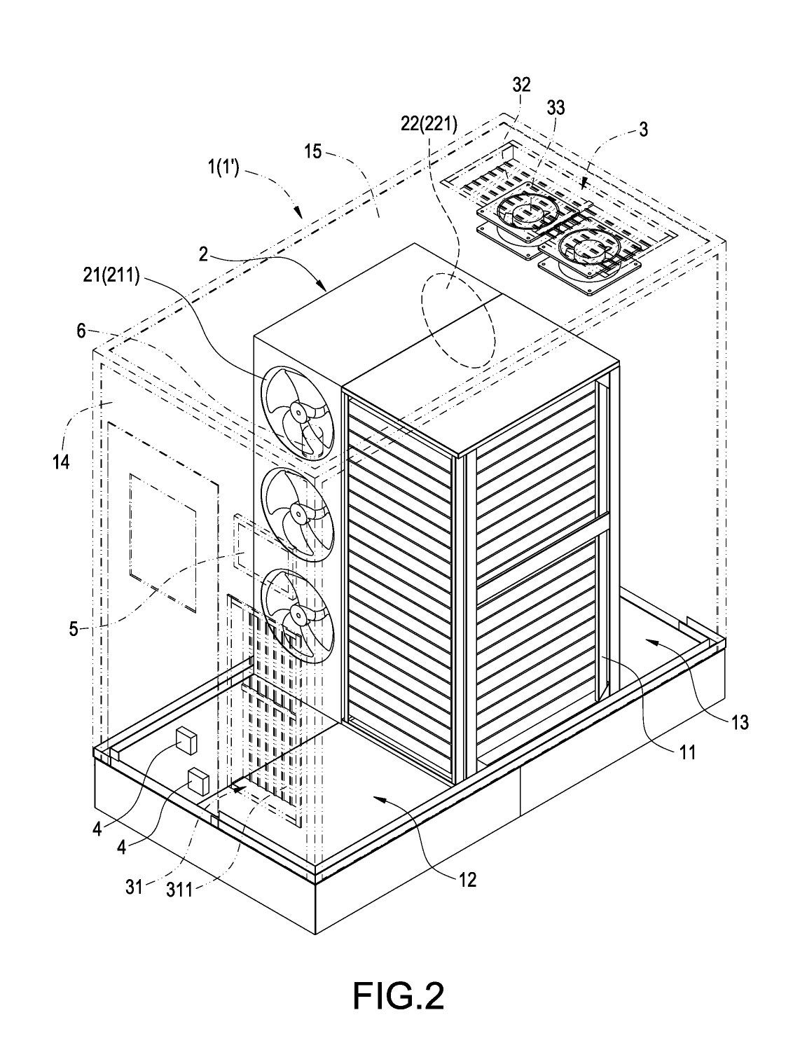

With reference to FIGS. 2 to 4, the present invention provides a rack system and a ventilation apparatus thereof, and the rack system comprises a closed rack 1′, a chassis 11 and a cooling device 2.

The chassis 11 is installed in the closed rack 1′, wherein information equipments such as the servers can be placed or installed in the chassis 11.

The cooling device 2 is contained in the closed rack 1′ and arranged adjacent and parallel to the chassis 11, and the cooling device 2 and the chassis 11 jointly separate an interior space of the closed rack 1′ into a cold air channel 12 and a hot air channel 13, and the cooling device 2 an air outlet 21 and an air inlet 22, and the air outlet 21 is corresponsive to the cold air channel 12, and the air inlet 22 is corresponsive to the hot air channel 13; wherein the cooling device 2 can be a direct expansion air conditioner or a chilled-water air conditioner. The present invention further comprises a sensor 4 and a controller 5, and the sensor 4 is installed at the cold air channel 12 for sensing a temperature change in a space and outputting an electrical signal, and the controller 5 is electrically coupled to the cooling device 2 and the sensor 4, and the controller 5 receives an electrical signal to control the air flow or temperature at the air outlet 21 of the cooling device 2.

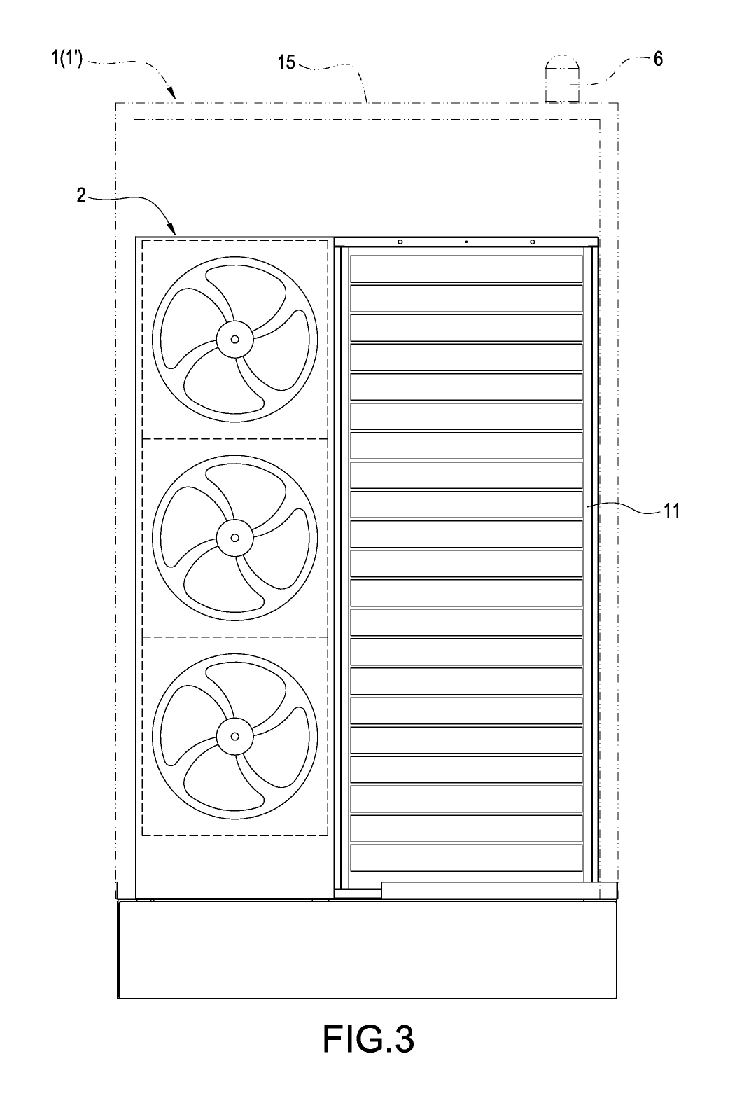

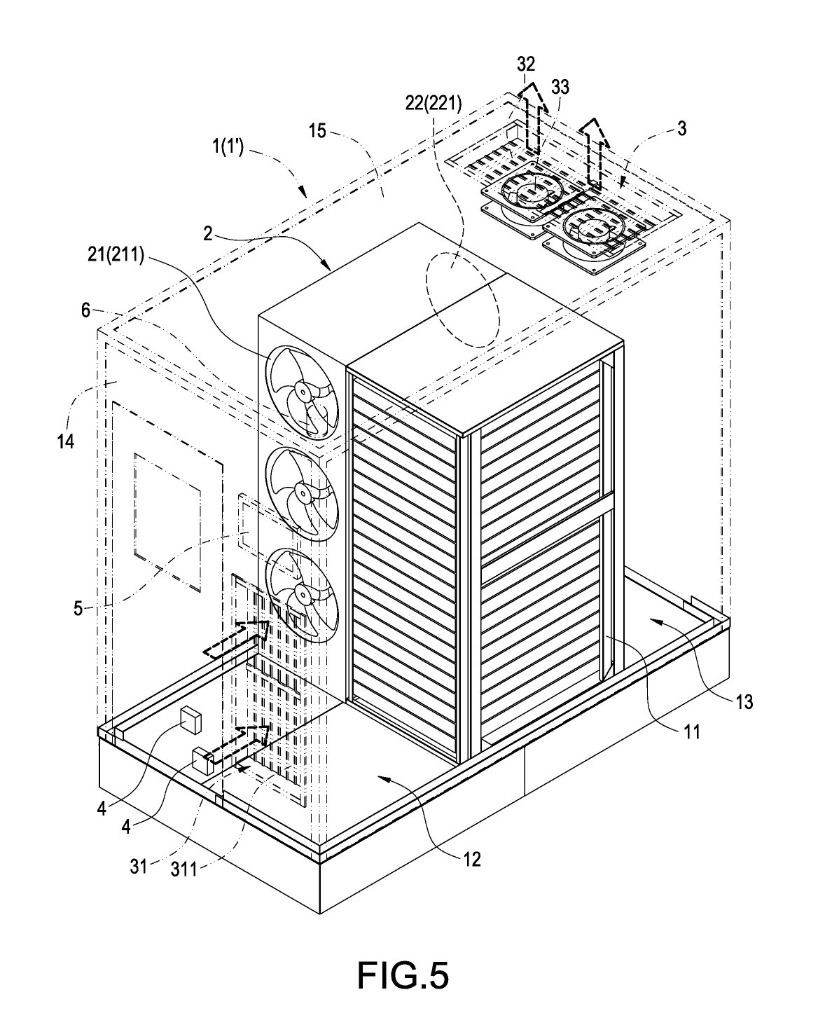

With reference to FIG. 5 together with FIGS. 2 and 3, a ventilation apparatus of the rack system comprises a rack 1, a chassis 11, a cooling device 2, a ventilation device 3, two sensors 4 and a controller 5.

The chassis 11 is installed in the rack 1, wherein information equipments such as servers can be stacked in the chassis 11, and the rack 1 has a front wall 14 and a ceiling 15.

The cooling device 2 is disposed in the rack 1 and adjacent and parallel to the chassis 11, and the cooling device 2 and the chassis 11 jointly separate the interior space of the rack 1 into a cold air channel 12 and a hot air channel 13, and the cooling device 2 has an air outlet 21 and an air inlet 22, and the air outlet 21 is corresponsive to the cold air channel 12, and the air inlet 22 is corresponsive to the hot air channel 13. Wherein, the air outlet 21 is a switching air outlet 211, and the air inlet 22 is a switching air inlet 221, and the cooling device 2 is a direct expansion air conditioner or a chilled-water air conditioner.

The ventilation device 3 includes a switching air extraction door 31, a switching air exhaustion door 32 and a switching extraction fan 33, and the switching air extraction door 31 has a filter 311 installed thereon; the switching air extraction door 31 is installed at the rack 1 and corresponsive to the cold air channel 12; and the switching extraction fan 33 is installed at the rack 1 and corresponsive to the hot air channel 13. More specifically, the switching air extraction door 31 is disposed on the front wall 14, and the switching air exhaustion door 32 is disposed on the ceiling 15, but the actual positions are not limited to those of this preferred embodiment only, and the switching extraction fan 33 can be installed on the switching air extraction door 31 or the switching air exhaustion door 32.

A sensor 4 is installed at the cold air channel 12 for sensing a temperature change in a space and outputting an electrical signal; another sensor 4 is installed outside the rack 1 for sensing a temperature change of external air (which is the ambient temperature of the external periphery of the rack 1) and outputting an electrical signal. More specifically, if the sensor 4 at the cold air channel 12 detects a temperature in a space is higher than a predetermined temperature such as 35° C. (this temperature can be set by the user, but is not limited to 35° C. only), an electrical signal will be generated. If the sensor 4 at the exterior of the rack 1 detects a temperature of the external air lower than the predetermined temperature such as 25° C. (this temperature can be set by the user, but is not limited to 25° C. only), an electrical signal will be generated.

The controller 5 and the cooling device 2 are electrically coupled to each respective sensor 4, and the controller 5 is used for receiving the electrical signal to turn on the ventilation device 3 and close the cooling device 2.

The present invention further comprises an alarm 6 electrically coupled to the sensor 4 of the cold air channel 12, and the alarm will be turned on if the sensor 4 of the cold air channel 12 generates an electrical signal.

The assembly of the rack system and the ventilation apparatus of the present invention provides two modes: a closed circulation mode and a ventilation mode of the rack 1 based on the temperature of the cold air channel 12 and the external temperature of the rack 1.

If the sensor 4 of the cold air channel 12 senses a temperature in a space is lower than 35° C., or the sensor 4 at the exterior of the rack 1 senses a temperature of external air is higher than 25° C., the system will be set to the closed circulation mode automatically. In the closed circulation mode, the rack 1 used in the assembly of the rack system of the present invention is a closed rack 1′, wherein the chassis 11 is installed in the closed rack 1′; and the cooling device 2 is contained in the closed rack 1′ and disposed adjacent and parallel to the chassis 11, and the cooling device 2 and the chassis 11 jointly separate the interior space of the closed rack 1′ into a cold air channel 12 and a hot air channel 13, and the cooling device 2 has an air outlet 21 and an air inlet 22, and the air outlet 21 is corresponsive to the cold air channel 12, and the air inlet 22 is corresponsive to the hot air channel 13.

As described above, the adjacent and parallel cooling device 2 and chassis 11 jointly separate the interior space of the closed rack 1′ into the cold air channel 12 and the hot air channel 13, so that an opening formed on a side of the chassis 11 is interconnected to the cold air channel 12 to allow cold air to blow out from the air outlet 21 into the cold air channel 12 uniformly, and the servers stacked in the chassis 11 can achieve the uniform heat dissipating effect to prevent the problem of having a higher temperature at the top of the chassis 11 and a lower temperature at the bottom of the chassis 11. In the meantime, the heat generated by the servers can be dissipated directly to the hot air channel 13, and finally the hot air of the hot air channel 13 is extracted away from the closed rack 1′ through the air inlet 22, so that the rack system of the present invention can shorten the air delivery distance. The invention not only reduces the work done in the air, but also reduces the energy loss during the air delivery process. Obviously, the rack system of the present invention provides high energy efficiency.

Further, the closed rack 1′ comes with a closed space, so that it is not necessary to take the airflow of the external environment into consideration, and the closed rack 1′ can be installed at any place of the office or factory. In the meantime, the closed rack 1′ has an independent cooling device 2 installed therein and capable of isolating the noises produced by the server fan and the cooling device 2, and hot air will not be discharged to affect the external environment and the staffs in the office or factory.

If the sensor 4 of the cold air channel 12 senses the temperature of a space is higher than 35° C., or the sensor 4 at the exterior of the rack 1 senses the temperature of external air is lower than 25° C., the system will be set to the ventilation mode automatically. In the ventilation mode, the assembly of the rack system and the ventilation apparatus of the present invention includes a chassis 11 installed in the rack 1; the cooling device 2 is contained in the rack 1 and disposed adjacent and parallel to the chassis 11, and the cooling device 2 and the chassis 11 jointly separate the interior space of the rack 1 into a cold air channel 12 and a hot air channel 13, and the cooling device 2 has an air outlet 21 and an air inlet 22, and the air outlet 21 is corresponsive to the cold air channel 12, and the air inlet 22 is corresponsive to the hot air channel 13; the ventilation device 3 includes a switching air extraction door 31 and a switching air exhaustion door 32 installed at the rack 1, and the switching air extraction door 31 is corresponsive to the cold air channel 12, and the switching air exhaustion door 32 is corresponsive to the hot air channel 13; a sensor 4 is installed at the cold air channel 12 for sensing a temperature change of a space and outputting an electrical signal, and another sensor 4 is installed at the exterior of the rack 1 for sensing a temperature change of external air and outputting an electrical signal; the controller 5 and the cooling device 2 are electrically coupled to each sensor 4, and the controller 5 is used for receiving the electrical signal to turn on the ventilation device 3 and shut the cooling device 2.

The rack system of the present invention may have the following special situations.

A high temperature occurs inside a cold air channel due to the failure of the cooling device 2 (wherein the temperature of the cold air channel 12 is higher than 35° C., and this predetermined temperature can be set by users, but not limited to 35° C. only), and the system will turn on the ventilation device 3 and shut the cooling device 2, so that external airflow is guided and used for dissipating and discharging the heat to achieve the effect of lowering the temperature of the rack system of the present invention immediately in urgent cases.

A low temperature occurs at the exterior of the rack 1. The external airflow can be used directly as a cooling airflow (wherein the temperature of the exterior of the rack 1 is lower than 25° C., and this predetermined temperature can be set by users, but not limited to 25° C. only), and the system will also turn on the ventilation device 3 and shut the cooling device 2, so that external airflow is guided and used for dissipating and discharging the heat to achieve the power saving effect of the rack system of the present invention.

In addition, the present invention uses the chassis 11 to separate the cold air channel 12 and the hot air channel 13 to avoid a short circulation of cold and hot air and assure the cold air to flow into the chassis 11 in order to improve the heat dissipating efficiency of the rack system of the present invention. The rack system and the ventilation apparatus of the present invention come with independent heat dissipating systems, so that they can be used simply by connecting to a network and a power cord. The rack system of the present invention has the feature of an easy installation.

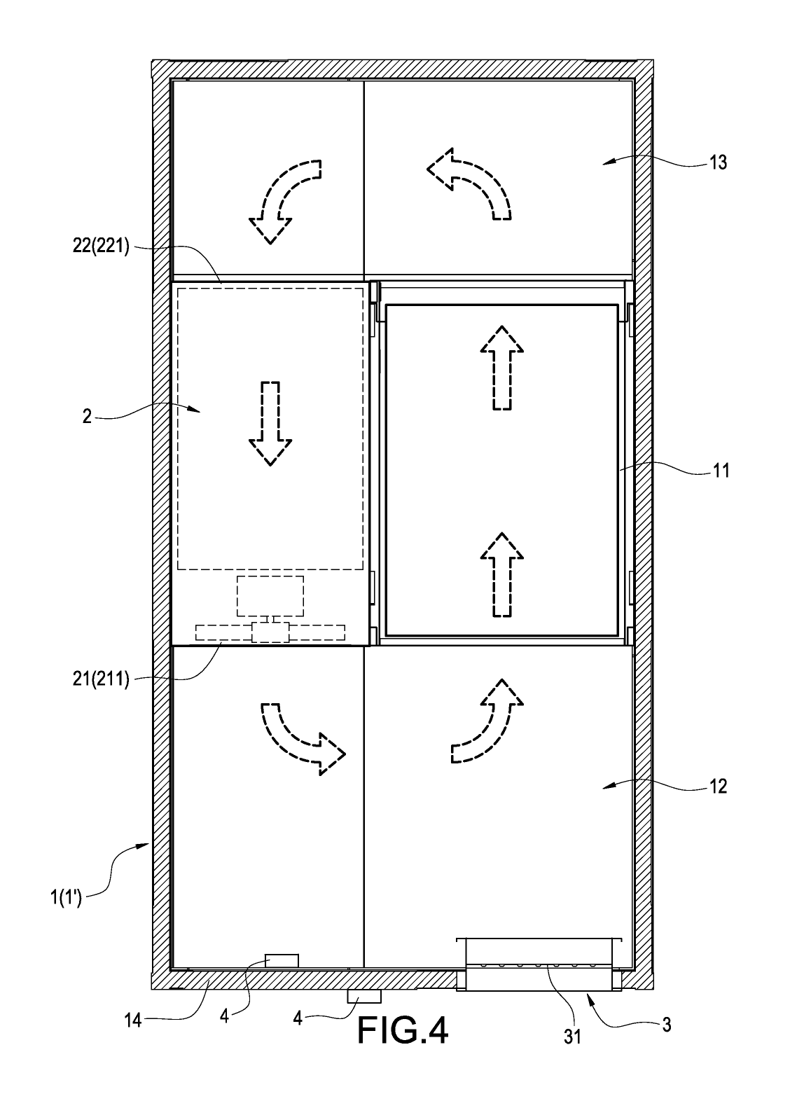

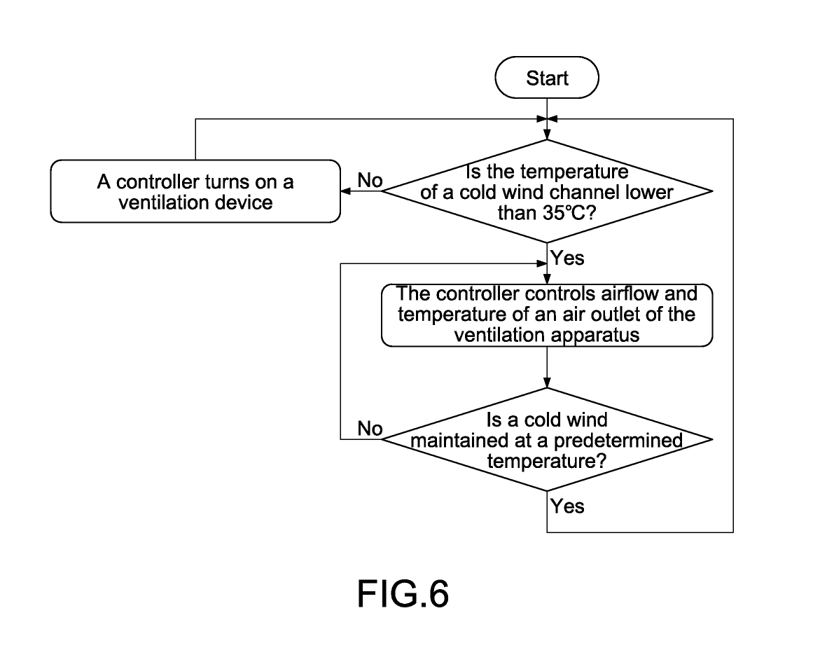

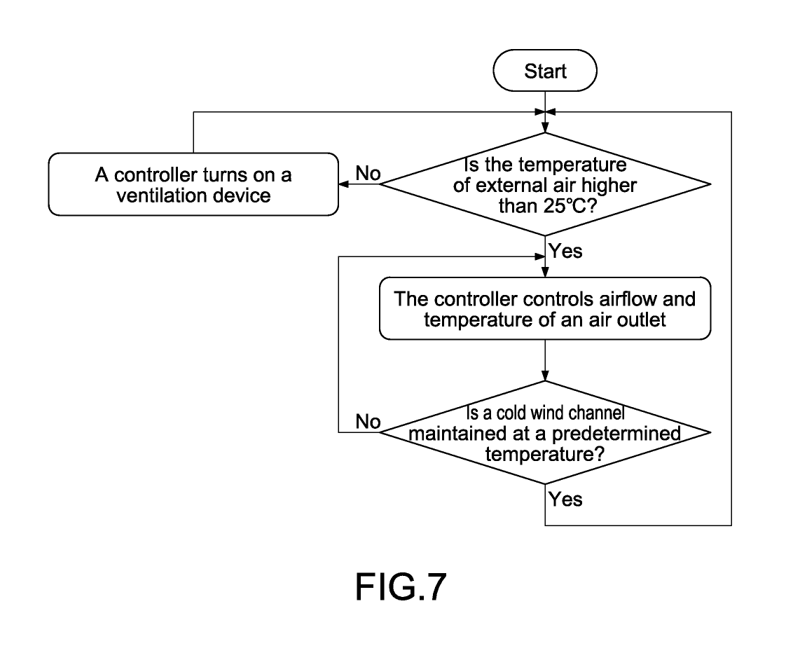

With reference to FIGS. 6 and 7 for flow charts of a rack system of the present invention, and together with FIGS. 4 and 5, if the sensor 4 of the cold air channel 12 senses the temperature of a space and outputs an electrical signal if the sensed temperature is higher or lower than 35° C., then the controller 5 will receive the electrical signal to control the air flow or temperature of the air outlet 21 of the cooling device 2 until the temperature of the cold air channel 12 is maintained at the user's set temperature, and this process is taken place in the closed circulation mode. In FIG. 4, the cooling device 2 will drive the cold air to blow out from the air outlet 21 and the hot air drawn in the air inlet 22 in the closed circulation mode. In the meantime, both sides of the chassis 11 separate the cold air channel 12 and the hot air channel 13, so that the openings formed on both sides of the chassis 11 are interconnected to the cold air channel 12 and the hot air channel 13 respectively to assure that the cold air in the cold air channel 12 is guided into the chassis 11, and the heat generated by the servers is discharged to the hot air channel 13. Therefore, the rack system of the present invention forms a cold/hot air circulation system in the closed rack 1′ automatically, and the controller 5 is provided for adjusting the air flow or temperature of the air outlet 21 to the set temperature, and the variable flow can be controlled to reduce the electric power consumption, so as to achieve the energy saving effect.

In FIG. 6, when the temperature of the cold air channel 12 is higher than 35° C., such situation is generally caused by the failure of the cooling device 2. The predetermined temperature is not limited to 35° C. only, but can be set by users freely. The controller 5 is provided for receiving the electrical signal to open the ventilation device 3 and shut the cooling device 2. Now, the ventilation device 3 opens the switching air extraction door 31, the switching air exhaustion door 32 and the switching extraction fan 33, and this process is taken place in the ventilation mode. In FIG. 7, the ventilation device 3 in the ventilation mode guides the external airflow directly by the switching extraction fan 33 and uses the airflow to dissipate and discharge hot air. More specifically, the external airflow enters from the switching air extraction door 31 into the cold air channel 12, and cold air is guided into the chassis 11 to dissipate the heat generated by the servers to the hot air channel 13, and finally the hot air of the hot air channel 13 is discharged from the switching air exhaustion door 32 to achieve the effect of lowering the temperature of the rack system of the present invention immediately. In addition, if the temperature of the cold air channel 12 is higher than 35° C. (wherein this temperature is not limited to 35° C. only, but can be set by users freely), the situation of a failure of the cooling device 2 may occur, and the alarm such as a lit light or a siren will be issued to transmit an abnormal message to inform maintenance people to inspect the cooling device 2, so as to enhance the safety of using the rack system of the present invention.

In FIG. 7, if the sensor 4 at the exterior of the rack 1 senses the temperature of external air and determines that the temperature of the external air is higher or lower than 25° C., then an electrical signal will be outputted. If the temperature outside the rack 1 is higher than 25° C., then the controller 5 will receive the electrical signal to control the air flow or temperature of the air outlet 21 of the cooling device 2 until the temperature of the cold air channel 12 is maintained at the temperature set by the user, and this process is taken place in the closed circulation mode. In FIG. 4, the cooling device 2 in the closed circulation mode will drive cold air to blow out from the air outlet 21 and draw hot air into the air inlet 22. In the meantime, the chassis 11 separates the cold air channel 12 and the hot air channel 13 to assure that the cold air of the cold air channel 12 is guided into the chassis 11 to discharge the heat generated by the servers to the hot air channel 13, so that a cold/hot air circulation system is formed automatically in the closed rack 1′ of the rack system of the present invention, and the controller 5 is provided for adjusting the air flow or the temperature of the air outlet 21 to a predetermined temperature, and the variable flow is controlled to reduce the electric power consumption, so as to achieve the energy saving effect.

In FIG. 7, if the temperature of the exterior of the rack 1 is lower than 25° C., the controller 5 will be used to receive the electrical signal to turn on the ventilation device 3 and shut the cooling device 2. It is noteworthy to point out that the low temperature of 25° C. is usually caused by a low ambient temperature, and the predetermined temperature is not limited to 25° C. only, but this temperature can be set by users freely. Now, the ventilation device 3 opens the switching air extraction door 31, the switching air exhaustion door 32 and the switching extraction fan 33, and this process is taken place in the ventilation mode. In the ventilation mode, the temperature of external air is low, so that the external airflow can be used as a cooling airflow, and the ventilation device 3 can use the switching extraction fan 33 to guide the external airflow and use it directly for dissipating and discharging the heat. More specifically, the external airflow enters from the switching air extraction door 31 into the cold air channel 12, and cold air is guided into the chassis 11 to dissipate the heat generated by the servers to the hot air channel 13, and finally hot air of the hot air channel 13 is discharged from the switching air exhaustion door 32 to achieve the power saving effect of the rack system of the present invention.

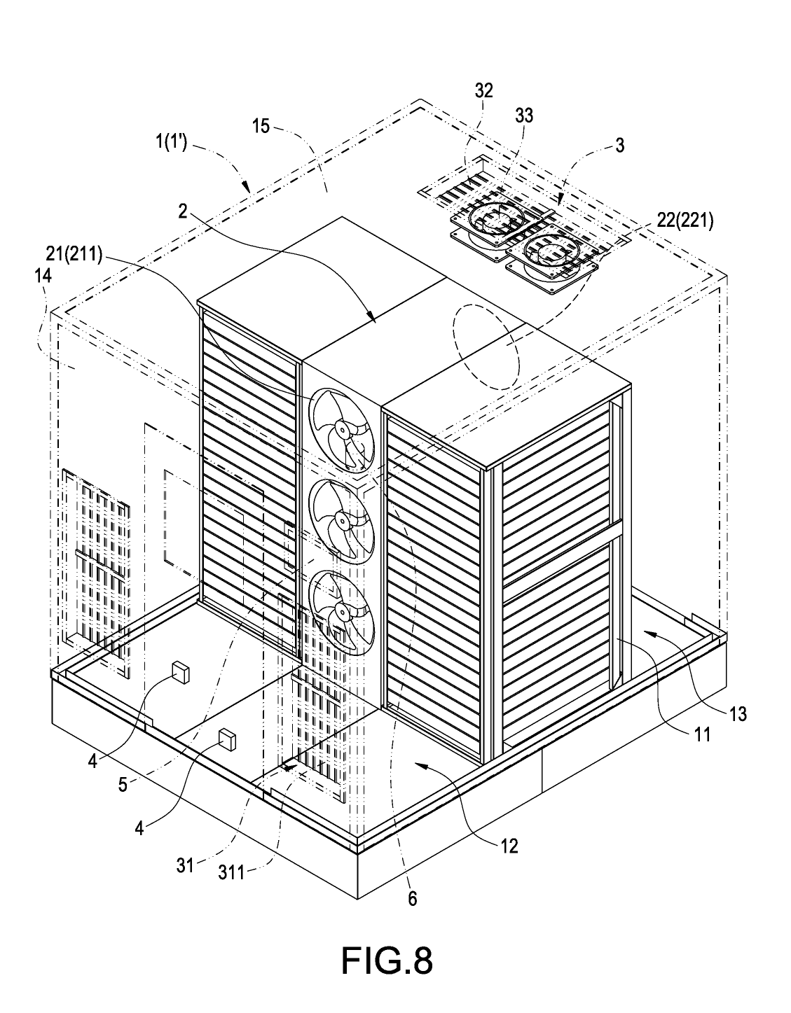

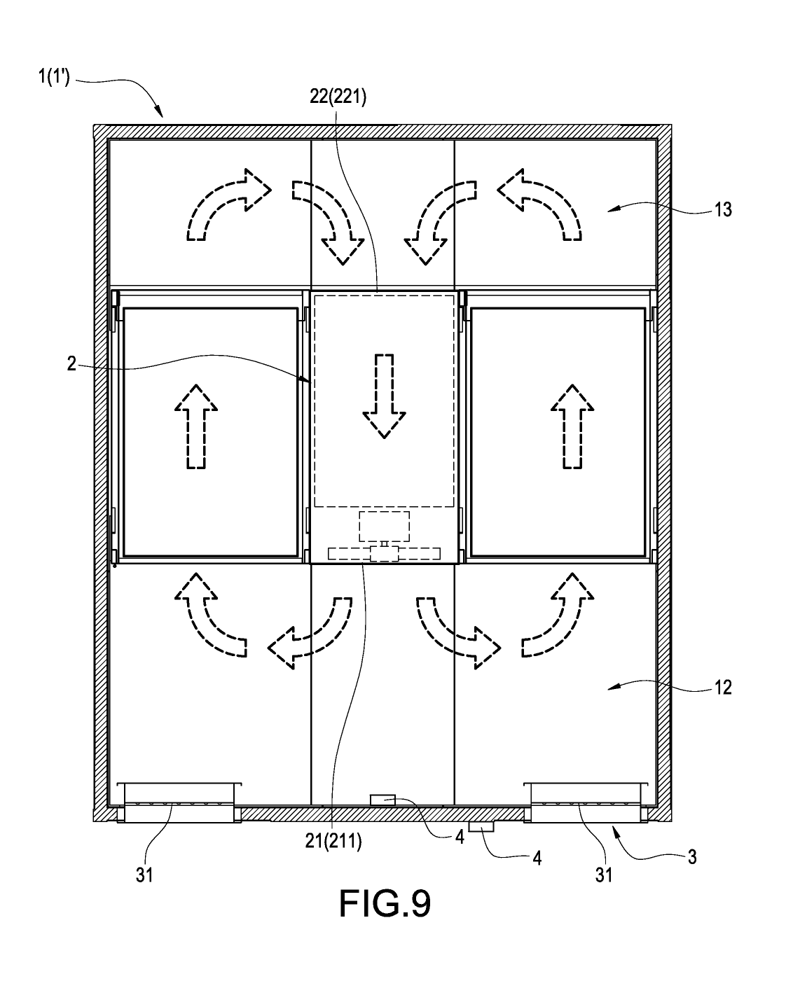

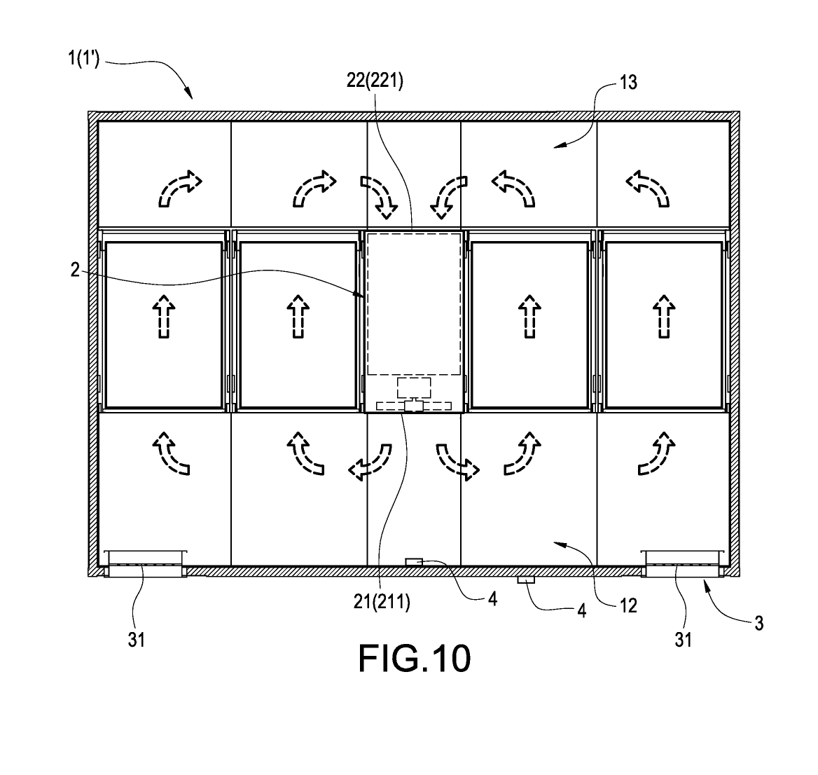

With reference to FIGS. 8 to 10 for the rack system in accordance with another preferred embodiment of the present invention, a rack 1 (or closed rack 1′) includes a plurality of chasses 11 installed therein to facilitate the capacity expansion or layout function of the servers, and the size of the rack 1 (or closed rack 1′) can be adjusted during the assembling process to expand the chassis 11. Since the space of the rack 1 (or closed rack 1′) is increased, plural cooling devices 2, switching air extraction doors 31, switching air exhaustion doors 32 and switching extraction fans 33 can be installed to stabilize the heat dissipating effect of the rack system of the present invention to avoid the problems of non-uniform temperature or heat accumulation in the rack 1 (closed rack 1′).

In summation of the description above, the rack system and the ventilation apparatus of the present invention improve over the prior art and comply with the patent application requirements, and thus the invention is duly filed for patent application. While the invention has been described by means of specific embodiments, numerous modifications and variations could be made thereto by those skilled in the art without departing from the scope and spirit of the invention set forth in the claims.

What is claimed is:

1. A rack system, comprising:
a closed rack;
a chassis, installed in the closed rack; and
a cooling device, installed in the closed rack and disposed adjacent and parallel to the chassis, and the cooling device and the chassis jointly separating an interior space of the closed rack into a cold air channel and a hot air channel, and the cooling device having an air outlet and an air inlet, and the air outlet being corresponsive to the cold air channel, and the air inlet being corresponsive to the hot air channel.

2. The rack system of claim 1, further comprising a sensor and a controller, and the sensor being installed at the cold air channel for sensing a temperature change of a space and outputting an electrical signal, and the controller being electrically coupled to the cooling device and the sensor, and the controller receiving the electrical signal to control an air flow or a temperature at the air outlet of the cooling device.

3. The rack system of claim 1, wherein the cooling device is a direct expansion air conditioner.

4. The rack system of claim 1, wherein the cooling device is a chilled-water air conditioner.

5. A ventilation apparatus of a rack system, comprising:
a rack;
a chassis, installed in the rack;
a cooling device, installed in the rack and disposed adjacent and parallel to the chassis, and the chassis jointly separating an interior space of the rack into a cold air channel and a hot air channel, and the cooling device having an air outlet and an air inlet, and the air outlet being corresponsive to the cold air channel, and the air inlet being corresponsive to the hot air channel;
a ventilation device, including a switching air extraction door and a switching air exhaustion door installed at the rack, and the switching air extraction door being arranged corresponding to the cold air channel, and the switching air exhaustion door being arranged corresponding to the hot air channel;
a sensor, installed at the cold air channel, for sensing a temperature change of a space and outputting an electrical signal; and
a controller, electrically coupled to the sensor, for receiving the electrical signal to turn on the ventilation device.

6. The ventilation apparatus of a rack system as recited in claim 5, wherein the air outlet is a switching air outlet, and the air inlet a switching air inlet, and the controller is electrically coupled to the cooling device for receiving the electrical signal to shut the cooling device.

7. The ventilation apparatus of a rack system as recited in claim 5, wherein if the temperature of the space sensed by the sensor is greater than 35° C., the electrical signal is generated.

8. The ventilation apparatus of a rack system as recited in claim 5, further comprising an alarm electrically coupled to the sensor, such that when the sensor generates the electrical signal, the alarm is turned on.

9. The ventilation apparatus of a rack system as recited in claim 5, wherein the rack has a front wall disposed on the front wall of the switching air extraction door.

10. The ventilation apparatus of a rack system as recited in claim 5, wherein the rack has a ceiling, and the switching air exhaustion door is disposed on the ceiling.

11. The ventilation apparatus of a rack system as recited in claim 5, wherein the ventilation device includes a switching extraction fan installed at the switching air extraction door.

12. The ventilation apparatus of a rack system as recited in claim 5, wherein the ventilation device includes a switching extraction fan installed at the switching air exhaustion door.

13. The ventilation apparatus of a rack system as recited in claim 5, wherein the switching air extraction door includes a filter installed thereon.

14. The ventilation apparatus of a rack system as recited in claim 5, wherein the cooling device is a direct expansion air conditioner.

15. The ventilation apparatus of a rack system as recited in claim 5, wherein the cooling device is a chilled-water air conditioner.

16. A ventilation apparatus of a rack system, comprising:
a rack;
a chassis, installed in the rack;
a cooling device, installed in the rack and disposed adjacent and parallel to the chassis, and the chassis jointly separating an interior space of the rack into a cold air channel and a hot air channel, and the cooling device having an air outlet and an air inlet, and the air outlet being corresponsive to the cold air channel, and the air inlet being corresponsive to the hot air channel;
a ventilation device, including a switching air extraction door and a switching air exhaustion door installed at the rack, and the switching air extraction door being arranged corresponding to the cold air channel, and the switching air exhaustion door being arranged corresponding to the hot air channel;
a sensor, installed outside the rack, for sensing a temperature change of outside air and outputting an electrical signal; and
a controller, electrically coupled to the sensor, for receiving the electrical signal to turn on the ventilation device.

17. The ventilation apparatus of a rack system as recited in claim 16, wherein the air outlet is a switching air outlet, and the air inlet is a switching air inlet, and the controller is electrically coupled to the cooling device, and the controller receives the electrical signal to turn of the cooling device.

18. The ventilation apparatus of a rack system as recited in claim 16, wherein the electrical signal is generated if the temperature of the outside air sensed by the sensor is less than 25° C.

19. The ventilation apparatus of a rack system as recited in claim 16, wherein the rack has a front wall, and the switching air extraction door is disposed on the front wall.

20. The ventilation apparatus of a rack system as recited in claim 16, wherein the rack has a ceiling, and the switching air exhaustion door is disposed on the ceiling.

21. The ventilation apparatus of a rack system as recited in claim 16, wherein the ventilation device includes a switching extraction fan installed at the switching air extraction door.

22. The ventilation apparatus of a rack system as recited in claim 16, wherein the ventilation device includes a switching extraction fan installed at the switching air exhaustion door.

23. The ventilation apparatus of a rack system as recited in claim 16, wherein the switching air extraction door includes a filter installed thereon.

24. The ventilation apparatus of a rack system as recited in claim 16, wherein the cooling device is a direct expansion air conditioner.

25. The ventilation apparatus of a rack system as recited in claim 16, wherein the cooling device is a chilled-water air conditioner.
